(19) United States
(12) Patent Application Publication
(10) Pub. No.: US 2014/0245582 A1
(43) Pub. Date: Sep. 4, 2014

(54) Apparatus for Assembling Camshaft

(71) Applicant: Mibo Co., Ltd., Hwaseong-shi (KR)

(72) Inventors: Yong Kyoon Kim, Suwon-si (KR); Ick Doo Eom, Suwon-si (KR); Chung Hwan Lee, Suwon-si (KR); Man Yun Go, Hwaseong-si (KR); In Chul Yu, Gunpo-si (KR)

(73) Assignee: Mibo Co., Ltd., Hwaseong-shi (KR)

(21) Appl. No.: 14/347,832

(22) PCT Filed: Sep. 27, 2012
(86) PCT No.: PCT/KR2012/007878

§ 371 Date: Mar. 27, 2014

(30) Foreign Application Priority Data
Sep. 28, 2011 (KR) 10-2011-0097975

(51) Int. Cl. B23P 19/04

(52) U.S. Cl. CPC B23P 19/042
USPC 29/240

(57) ABSTRACT

The present invention is used to manufacture a camshaft which is used in an engine for a vehicle. In detail, the present invention relates to an apparatus for assembling a cam having a depression with a shaft having a protrusion.

### TECHNICAL FIELD

The present invention relates, in general, to apparatuses for assembling camshafts for engines and, more particularly, to an apparatus for assembling a camshaft which can precisely assemble a cam with a shaft provided with a protrusion.

### BACKGROUND ART

Generally, a camshaft is provided with a plurality of cams which are provided on the shaft in different phases at positions spaced apart from each other at predetermined intervals. The camshaft is repeatedly rotated by rotational force of a crankshaft, thus periodically opening and closing an air-intake valve and an air-release valve of a combustion chamber so that the engine can be continuously operated.

Such conventional camshafts are manufactured in an integrated rod type in which both a cam and a shaft are integrally formed of the same material, or in an assembly type in which a cam manufactured by a separate process is joined with a shaft in a variety of manners.

The assembly type hollow camshaft can be lighter than the integrated camshaft. Furthermore, the assembly type is advantageous in that the cam and the shaft can be made of different materials to match characteristics of elements that respectively contact the cam and the shaft.

Particularly, in the case of an assembly type camshaft that is formed of sintered metal powder, there are several advantages in that the joining power between the cam and the shaft is comparatively high, and the durability and reliability of the product are superior.

The technical construction of the assembly type camshaft formed of sintered metal powder includes forming a plurality of longitudinal depressions in the circumferential outer surface of the shaft, and providing protrusions on the circumferential inner surface of an insert hole of a cam that is formed of metal powder so that the protrusions are inserted into the corresponding depressions. After the cam is assembled with the shaft, it is sintered and treated with heat of about 1000° C. or more in a furnace so that the cam and the shaft can be firmly joined with each other.

[Document 1] Korean Patent Registration No. 10-0799604

A method of manufacturing a camshaft according to a conventional technique disclosed in Document 1 includes: forming a cam in such a way that at least two protrusions are circumferentially formed on a circumferential inner surface of the cam; pre-sintering the formed cam such that it is maintained at a predetermined temperature; forming at least one protrusion on a surface of the shaft; fitting several pre-sintered cams over the shaft at positions corresponding to preset intervals and at predetermined phase angles and temporarily fastening the cams to the shaft; and main-sintering a product produced by assembling the cam with the shaft such that it is maintained at a predetermined temperature.

Moreover, in the technique of Document 1, the protrusion that is provided on the outer surface of the shaft is oriented in the longitudinal direction of the shaft. Thus, when fastening the cam to the shaft, a large load is applied to the cam, which may cause a crack in the cam.

[Document 2] Korean Patent Registration No. 10-0961709

FIG. 6 illustrates a technique disclosed in Document 2. In Document 2, an assembly means 300 includes a rotary body 310 which is provided on a first frame 1 and clamps a shaft that has been processed by a forming means. A second frame 2 is installed on the first frame 1. A cam supply unit 330 which stores cams and supplies them is provided on the second frame 2. A fixing pin 320 vertically moves in a coaxial direction with the rotating body 310 and holds the shaft.

The assembly means 300 is configured such that a cam supplied from the cam supply unit 330 is moved downwards and simultaneously the fixing pin 320 moves downward and pushes the upper end of the shaft downward. When the cam reaches a target location, the rotating unit 310 rotates in one direction, thus rotating the shaft so that the cam is reliably fastened to the shaft.

When the assembly means 300 is operated, the cam is supplied from the cam supply unit 330 onto the shaft. The supplied cam is fitted over the shaft in an axial direction. When the cam reaches a target location, the rotating body 310 rotates in one direction, so that the shaft that has been clamped by the rotating body 310 is rotated. At this time, a protrusion provided on the circumferential outer surface of the shaft comes into close contact with a protruding surface of the cam so that the cam is forcibly fixed to the shaft.

In the technique of Document 2, the cam is assembled with the shaft in such a way that the cam that has been supported by a bracket is moved downward and fitted over the shaft, and then the shaft is rotated relative to the cam. Therefore, if axial deformation of the cam or shaft occurs, when the cam moves downward, the cam or shaft may not be able to absorb it but may be damaged, thus causing an incorrect assembly.

Furthermore, the technique of Document 2 can process only cams of the same shape.

If a cam of another shape must be assembled with the shaft, the bracket must be replaced with another one or the design of equipment may have to be modified.

[Prior Art Document]

[Patent Document]

(Patent document 1) Korean Patent Registration No. 10-0799604

(Patent document 2) Korean Patent Registration No. 10-0961709

### DISCLOSURE OF INVENTION

### Technical Problem

Accordingly, the present invention has been made keeping in mind the above problems occurring in the prior art, and an object of the present invention is to provide an apparatus for assembling a camshaft which is able to enhance power by which a cam is fastened to a shaft, can precisely assemble the cam with the shaft, can prevent the surface of the cam or shaft from being damaged during the operation of assembling the cam with the shaft, and can assemble different kinds of cams with the shaft.

### Solution to Problem

In order to accomplish the above object, in an aspect, the present invention provides an apparatus for assembling a cam with a shaft, including: a holder clamping the cam having an opening; a drive unit clamping the shaft and moving the shaft in a vertical direction so that the shaft is inserted into the opening of the cam, the drive unit rotating the shaft; and a lift unit provided so as to be movable in the vertical direction so that the lift unit is able to support a lower end of the shaft, wherein the shaft is inserted into the cam while an upper end of the shaft is clamped by the drive unit and the lower end of the shaft is supported by the lift unit, and the holder comprises a receiving member receiving a portion of the cam, the receiving member sliding in a front-rear direction, and a support unit supporting a portion of the cam that protrudes out of the receiving member, the support unit sliding in a left-right direction, wherein while the shaft is moved downwards and inserted into the cam, the support unit does not come into contact with the cam, and while the shaft rotates so that the cam is fastened to the shaft, the support unit comes into contact with the cam.

The apparatus may further include an auxiliary cam holder clamping an auxiliary cam having a different shape from a shape of the cam, the auxiliary cam holder being disposed above the holder and provided so as to be slidable relative to the holder.

In another aspect, the present invention provides a method of assembling a cam to a shaft, including: providing the cam having a depression therein; inserting the shaft provided with a protrusion into the cam; and assembling the cam with the shaft in such a way that the shaft is rotated relative to the cam, wherein in the inserting, the shaft is inserted into the cam while an upper end of the shaft is fixed and a lower end thereof is supported, while the shaft is inserted into the cam, the cam can move relative to the shaft, and while the shaft rotates relative to the cam, the cam is fixed.

### Advantageous Effects of Invention

In an apparatus according to the present invention, a cam and a shaft are assembled with each other in such a way that the shaft is moved downward and rotated. Therefore, the apparatus is compact so that the installation space thereof can be reduced.

Furthermore, when the shaft is inserted into the cam, axial deformation of the cam or shaft which may be caused during the process of manufacturing it may be absorbed. Therefore, the assembly accuracy of the cam and shaft can be markedly enhanced.

In addition, when the shaft is inserted into the cam, a cam holding jig releases the cam. Therefore, even if axial deformation occurs, the present invention can prevent the cam from scratching the surface of the shaft.

Moreover, the present invention can not only assemble the cam with the shaft but can also assemble another kind of cam with the shaft.

### BRIEF DESCRIPTION OF DRAWINGS

FIG. 1 is a plan view of a cam;

FIG. 2 is a perspective view of a shaft;

FIG. 3 is a perspective view of a camshaft;

FIG. 4a is a perspective view illustrating the entirety of an assembly apparatus;

FIG. 4b is an enlarged view of a portion of the assembly apparatus;

FIGS. 5a through 5i are views illustrating a manufacturing process; and

FIG. 6 shows a conventional technique.

### MODE FOR THE INVENTION

Hereinafter, a preferred embodiment of the present invention will be described in detail with reference to the attached drawings.

[Forming a Cam]

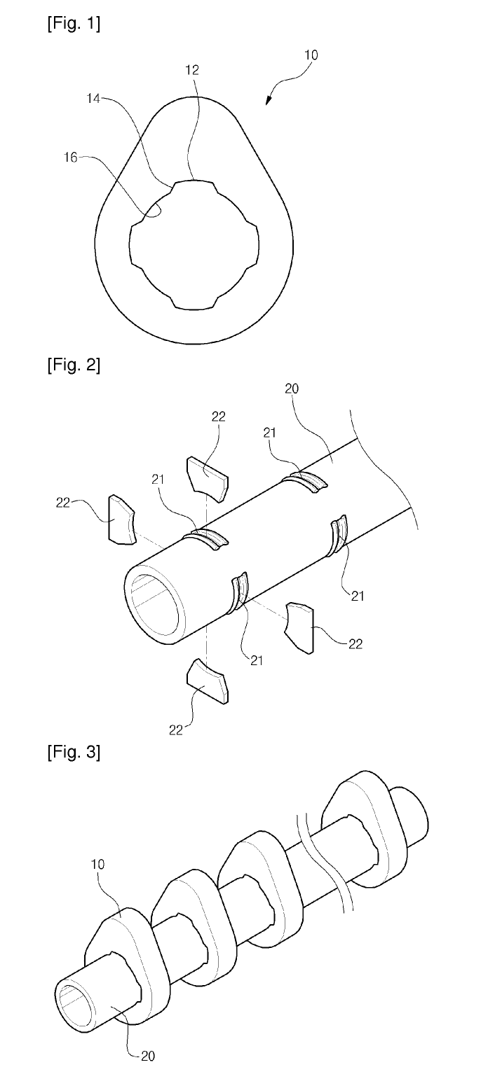

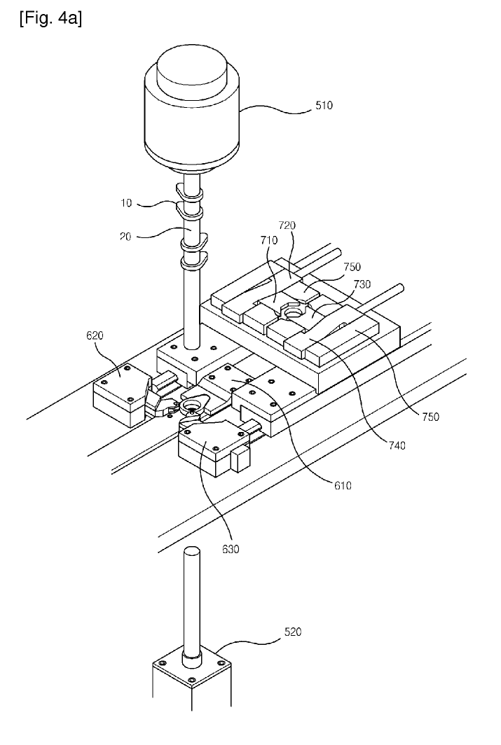

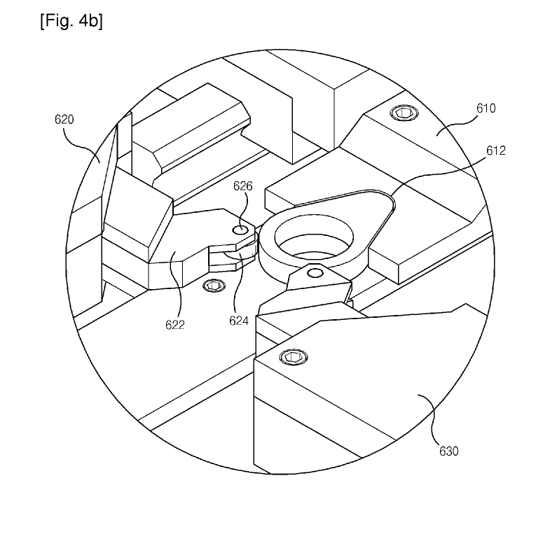

FIG. 1 illustrates a cam 10 having depressions 12 according to the present invention.

The circumferential inner surface of the cam 10 comprises depressions 12 which form a larger diameter, and small diameter portions 16. A ramp 14 is formed between each depression 12 and the adjacent small diameter portion 16.

[Shaft]

FIG. 2 illustrates a shaft 20 used in the present invention. The shaft 20 may comprise a hollow pipe. Recesses are circumferentially formed by recess-forming plates 22 in the circumferential outer surface of the shaft 20. A protrusion 21 is formed adjacent to each recess.

In this embodiment, the protrusion 21 extends a predetermined length in the circumferential direction of the shaft 20.

A plurality of protrusions 21 may be circumferentially formed on the circumferential outer surface of the shaft 20.

The length of each protrusion 21 with respect to the circumferential direction of the shaft 20 matches that of the corresponding depression 12 formed in the inner surface of the cam 10. Preferably, the width of the protrusions 21 with respect to the axial direction of the shaft 20 is less than that of the inner surface of the cam 10.

As such, in the case where the protrusion 21 of the shaft 20 extends a comparatively long length in the circumferential direction of the shaft 20, a load applied to the cam 10 can be reduced when assembling the cam 10 with the shaft 20. Thereby, not only can the possibility of a crack being caused in the cam 10 be minimized, but the reliability of fastening the cam 10 to the shaft 20 can also be enhanced because an area where the protrusion 21 protrudes can be increased.

[49]

[Fastening the Cam to the Shaft]

FIG. 3 illustrates the cams 10 and the shaft 20 that are fastened to each other by a fastening operation.

First, the shaft 20 is inserted into the cam 10 such that the protrusions 21 of the shaft 20 are disposed in the corresponding depressions 12 of the cam 10.

In the fastening operation, it is preferable that when the shaft 20 is inserted into the cam 10, the shaft 20 is guided by the chamfers 14 of the cam 10.

When the shaft 20 is rotated while the cam 10 is fixed, the protrusions 21 pass over the corresponding ramps 14.

The shaft 20 is rotated with respect to the cam 10 until the protrusions 21 of the shaft 20 are disposed in the corresponding small diameter portions 16 formed in the inner surface of the cam 10.

The cam 10 and the shaft 20 are fastened to each other by this rotation.

Of course, fastening the cam 10 to the shaft 20 can be realized by rotating the cam 10 while the shaft 20 is fixed.

When the rotation of the shaft 20 relative to the cam 10 is completed, a space is determined between the circumferential outer surface of the shaft 20 and each depression 12 of the cam 10.

Furthermore, in the present invention, the protrusions 21 that are circumferentially formed on the circumferential outer surface of the shaft 20 and the ramps 14 that are formed in the cam 10 reduce load stress applied to the cam 10 when fastening the cam 10 to the shaft 20, thus preventing a crack which makes a defective product from being caused in the cam 10, and enhancing the power by which the cam 10 is fastened to the shaft 20.

[The Construction of an Assembly Apparatus]

An assembly apparatus according to the present invention includes a holder 610, 620 and 630, a drive unit 510 and a lift unit 520. The holder 610, 620 and 630 clamps the cam 10 which has an opening therein. The drive unit 510 clamps the shaft 20 and vertically moves it so that the shaft 20 is inserted into the opening of the cam 10. The drive unit 510 can also rotate the shaft 20. The lift unit 520 is provided so as to be vertically movable so that it can support a lower end of the shaft 20. While an upper end of the shaft 20 is fixed by the drive unit 510 and the lower end thereof is supported by the lift unit 520, the shaft 20 is inserted into the cam 10.

[Holder]

The holder 610, 620 and 630 of the present invention comprises a receiving member 610 and support units 620 and 630.

The receiving member 610 receives a portion of the cam 10 and slides forward and rearward. A depression 612 which has a shape corresponding to that of an elliptical portion of the cam 10 is formed in the receiving member 610 so that the receiving member 610 can receive the elliptical portion of the cam 10.

The support units 620 and 630 support portions of the cam 10 that protrude out of the receiving member 610. The support units 620 and 630 are configured to slide leftward and rightward. It is preferable for the support units 620 and 630 to support a circular portion of the cam 10.

Furthermore, it is preferable that the support units 620 and 630 comprise a left support unit 620 and a right support unit 630.

The left support unit 620 includes a left frame 622, a left roller 624 which is provided between an upper protruding part and a lower protruding part of the left frame 622, and a left pin 626 which is provided to enable the left roller 624 to rotate relative to the left frame 622. The left frame 622 can be slid to the left or the right by a hydraulic or pneumatic cylinder (not shown).

Preferably, the structure of the right support unit 630 is the same as that of the left support unit 620. In other words, the right support unit 630 includes a right frame, a right roller which is provided between an upper protruding part and a lower protruding part of the right frame, and a right pin which is provided to enable the right roller to rotate relative to the right frame. The right frame of the right support unit can be slid to the left or the right by a hydraulic or pneumatic cylinder (not shown).

[Drive unit]

The drive unit 510 of the present invention is disposed above the holder 610, 620 and 630.

The drive unit 510 is configured such that it clamps the circumferential outer surface of the upper end of the shaft 20, vertically moves the shaft 20, and rotates the shaft 20 in a clockwise or counterclockwise direction.

The drive unit 510 can be moved upward or downward by a hydraulic or pneumatic cylinder (not shown). In lieu of the hydraulic or pneumatic cylinder, a screw and nut may be used to move the drive unit 510 upward or downward.

The drive unit 510 is provided with a member which can releasably clamp the shaft 20 in the same manner as does a chuck of a machining tool.

[Lift Unit]

The lift unit 520 of the present invention is disposed below the holder 610, 620 and 630.

The lift unit 520 includes a rod which supports the lower end of the shaft 20 and moves along with the shaft 20.

The rod can be moved upward or downward by a hydraulic or pneumatic cylinder.

[Auxiliary Cam Holder]

The present invention further includes an auxiliary cam holder 710, 720, 730, 740 and 750 which can clamp an auxiliary cam which has a different shape from the cam 10.

The auxiliary cam holder 710, 720, 730, 740 and 750 is disposed behind and above the holder 610, 620 and 630. The auxiliary cam holder 710, 720, 730, 740 and 750 is provided so as to be slidable in a front-rear direction relative to the holder 610, 620 and 630.

The shape of the auxiliary cam is different from that of the cam 10. In the drawings, the shape of the cam 10 is that of a combination of a circle and an ellipse, while the auxiliary cam has an octagonal shape.

The auxiliary cam holder 710, 720, 730, 740 and 750 includes auxiliary cam receiving members 710 and 730.

The auxiliary cam receiving members 710 and 730 comprise a left auxiliary cam receiving member 710 and a right auxiliary cam receiving member 730.

The left auxiliary cam receiving member 710 and the right auxiliary cam receiving member 730 can slide leftward and rightwards under the guidance of a guide 750. Each of the left and right receiving members 710 and 730 has a depression which has a shape corresponding to the perimeter shape of the auxiliary cam.

Further, a slant surface is formed in each of the left and right receiving members 710 and 730.

A left cam plate 720 and a right cam plate 740 are respectively disposed on outer ends of the left receiving member 710 and the right auxiliary cam receiving member 730.

A slant surface is formed in each of the left and right cam plates 720 and 740.

The left cam plate 720 and the right cam plate 740 can slide in the front-rear direction under the guidance of the guide 750.

The slant surfaces of the left and right receiving members 710 and 730 respectively come into contact with the slant surfaces of the left and right cam plates 720 and 740. Upon the left cam plate 720 and the right cam plate 740 moving in the front-rear direction, the left receiving member 710 and the right receiving member 730 slide in the left-right direction.

Springs are provided to reliably and smoothly slide the left receiving member 710 and the right receiving member 730. In detail, after the left cam plate 720 and the right cam plate 740 have moved forward and the left receiving member 710 and the right receiving member 730 have slid approaching each other, when the left cam plate 720 and the right cam plate 740 move rearward, the left receiving member 710 and the right receiving member 730 can be reliably and smoothly moved away from each other by the springs.

[Assembly Process—Outline]

A method of assembling the cam to the shaft according to the present invention includes: providing the cam 10 having the depressions; inserting the shaft 20 having the protrusions into the cam 10; and rotating the shaft 20 relative to the cam 10 so that the cam 10 is fastened to the shaft 20. The inserting operation is characterized in that the shaft 20 is inserted into the cam 10 while the upper end of the shaft 20 is clamped and the lower end thereof is supported.

In the method of assembling the cam to the shaft according to the present invention, while the shaft 20 is inserted into the cam 10, the cam 10 can move relative to the shaft 20. Furthermore, while the shaft 20 rotates relative to the cam 10, the cam 10 is maintained in the fixed state.

[Assembly Process—Providing the Cam]

A cam supply unit supplies the cam 10 to the receiving member 610. The elliptical portion of the cam 10 is seated into the elliptical depression 612 of the receiving member 610.

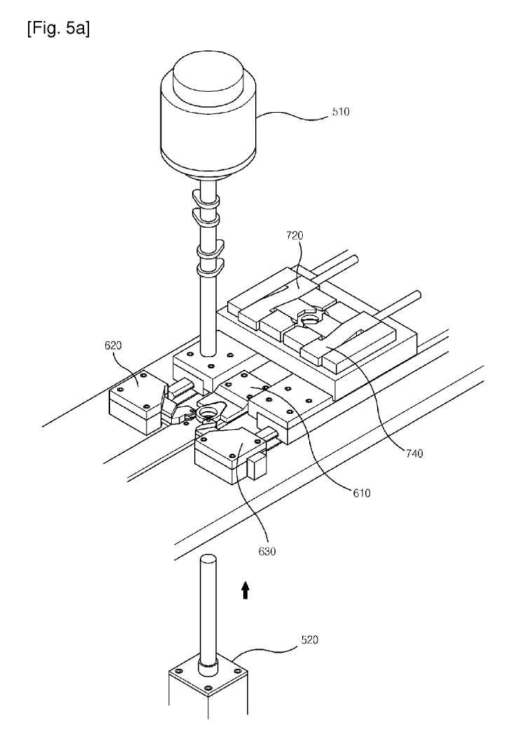

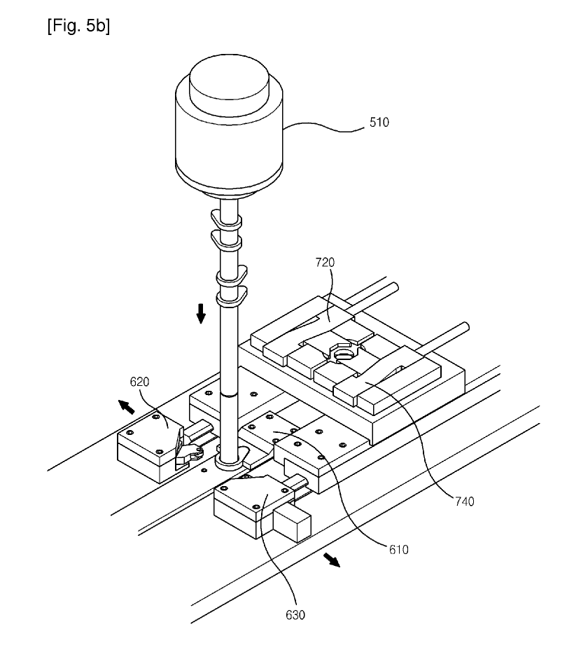

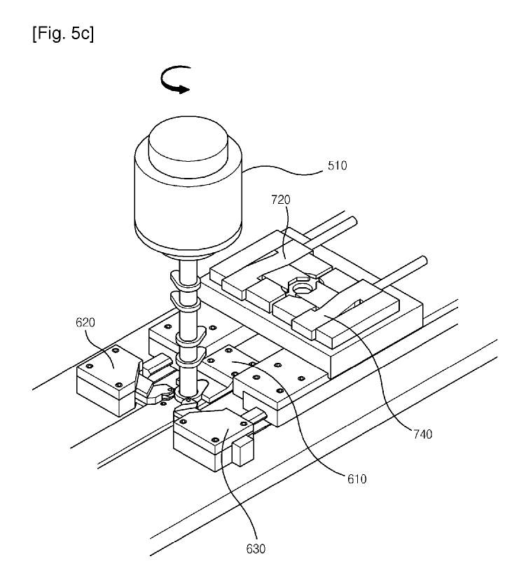

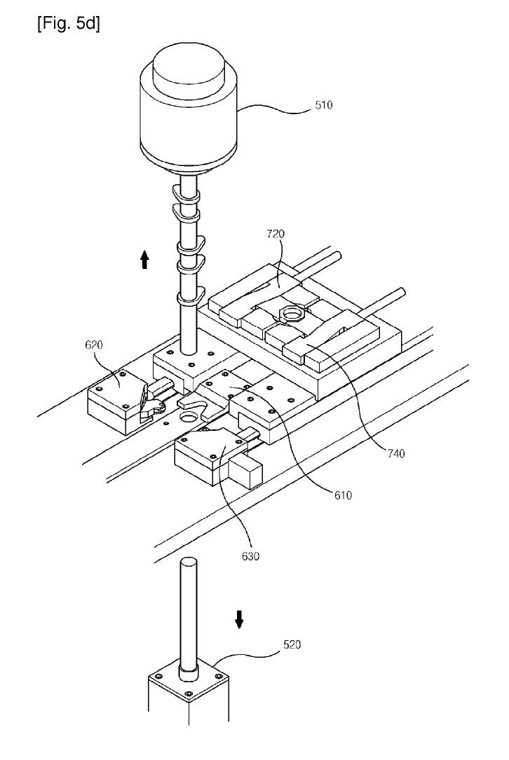

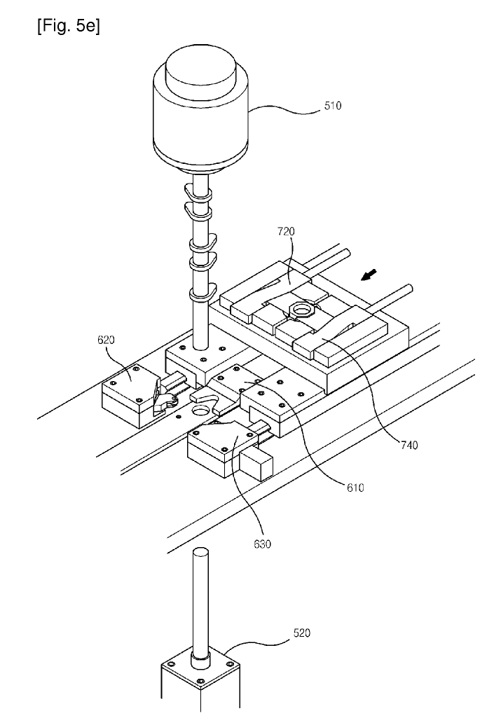

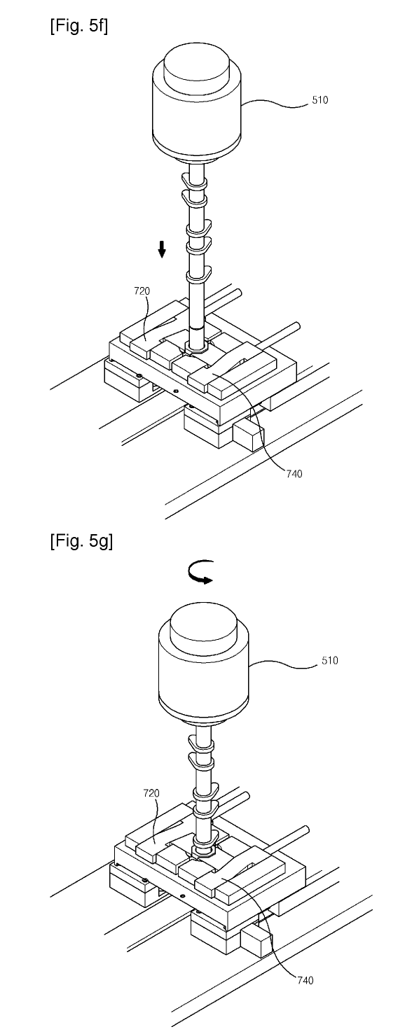

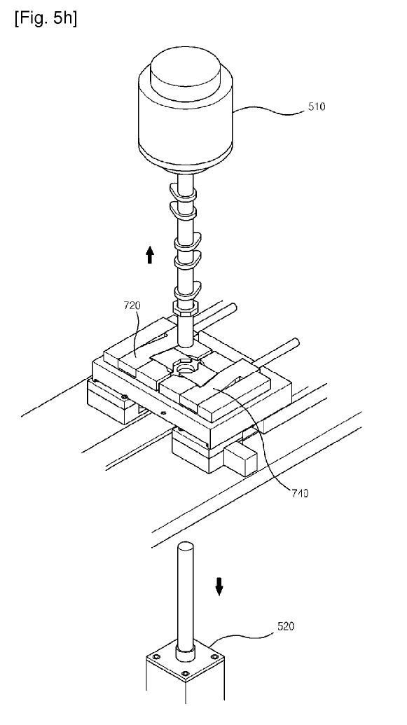

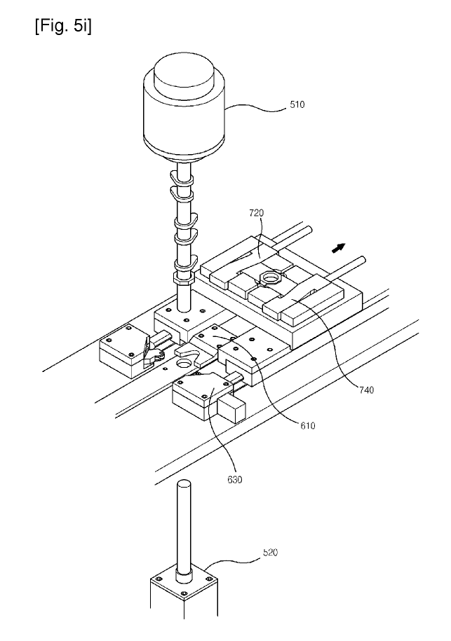

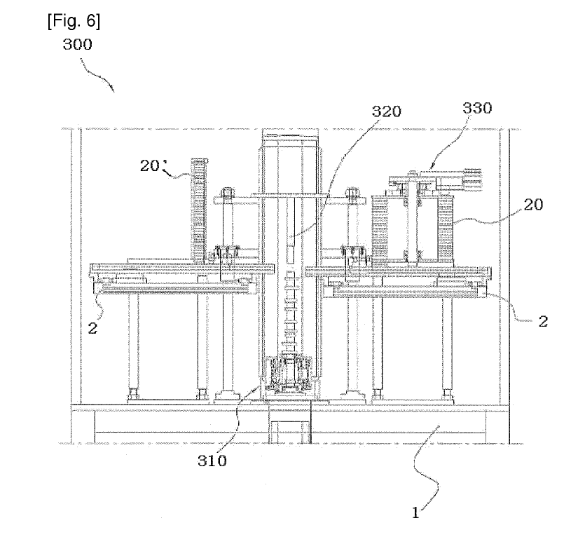

Thereafter, the left support unit 620 moves to the right and the right support unit 630 moves to the left, so that the left support unit 620 and the right support unit 630 come into contact with the circular portion of the cam 10 (refer to FIG. 5a). It is preferable that the left support unit 620 and the right support unit 630 slide two times and come into contact with the circular portion of the cam 10 so that the cam 10 can be precisely positioned in the receiving member 610.

[Assembly Process—the Drive Unit and Lift Unit]

While the left support unit 620 and the right support unit 630 are put into contact with the circular portion of the cam 10, the lift unit 520 moves upward (refer to FIG. 5a). The lift unit 520 moves upward until the upper end of the rod of the lift unit 520 comes into contact with the lower end of the shaft 20 (see FIG. 5b).

The left support unit 620 moves to the left and the right support unit 630 moves to the right so that the left support unit 620 and the right support unit 630 are removed from the cam 10.

While the lift unit 510 clamps the upper end of the shaft 20 and the lift unit 520 supports the lower end of the shaft 20, the lift unit 510 moves downward so that the shaft 20 is inserted into the cam 10.

That is, when the shaft 20 is moved downward and inserted into the cam 10, the cam 10 is maintained in the state of having been received in the receiving member 610, but the left support unit 620 and the right support unit 630 have been removed from the cam 10. Therefore, the cam 10 can move in a direction perpendicular to the shaft 20 and finely rotate.

[Assembly Process—Rotating the Shaft]

The left support unit 620 moves to the right and the right support unit 630 moves to the left so that the left support unit 620 and the right support unit 630 come into contact with the cam 10.

Then, the cam 10 is supported by the receiving member 610, the left support unit 620 and the right support unit 630.

The shaft 20 thereafter rotates relative to the cam 10 so that the cam 10 and the shaft 20 are assembled with each other (refer to FIG. 5c).

That is, in the present invention, when the shaft 20 is rotating relative to the cam 10, because the cam 10 is received in the receiving member 610 and the left support unit 620 and the right support unit 630 make a contact with the cam 10 and support it, the cam 10 cannot move relative to the holder. In other words, while the shaft 20 rotates relative to the cam 10, the cam 10 is fixed in place by the holder.

[Assembly Process—Moving the Shaft Upward]

After the cam 10 is fastened to a predetermined portion of the shaft 20, the receiving member 610 moves rearward, the left support unit 620 to the left, and the right support unit 630 to the right so that the receiving member 610, the left support unit 620 and the right support unit 630 are removed from the cam 10.

The cam 10 and the shaft 20 that have been assembled with each other are moved upward by the drive unit 510. Meanwhile, the lift unit 520 moves downward (refer to FIG. 5d).

[Assembly Process—Assembling Other Cams with the Shaft]

Other cams 10 are assembled with the shaft 20 by repeating the above-mentioned assembly operation.

[Assembly Process—Providing the Auxiliary Cam]

When the camshaft in which the cams 10 have been assembled with the shaft 20 has moved upward, the receiving member 610 has moved rearward, the left support unit 620 to the left, the right support unit 630 to the right, and the lift unit 520 downward.

The auxiliary cam is supplied to the auxiliary cam holder 710, 720, 730, 740 and 750 by a separate auxiliary cam supply unit and then clamped by the auxiliary cam holder 710, 720, 730, 740 and 750.

When it is necessary to assemble the auxiliary cam with the shaft, the auxiliary cam holder 710, 720, 730, 740 and 750 to which the auxiliary cam has been fixed is moved forward (refer to FIG. 5e).

[Assembly Process—Assembling the Auxiliary Cam]

The assembling the auxiliary cam is conducted by repeating the operation of the drive unit 510 and the lift unit 520 that have been used in the operation of assembling the cam 10 with the shaft 20.

In detail, after the auxiliary cam holder 710, 720, 730, 740 and 750 has moved forward, the lift unit 520 moves upward until the rod of the lift unit 520 comes into contact with the lower end of the shaft 20.

While the lift unit 510 clamps the upper end of the shaft 20 and the lift unit 520 supports the lower end of the shaft 20, the lift unit 510 moves downward so that the shaft 20 is inserted into the auxiliary cam (refer to FIG. 5f).

Thereafter, the drive unit 510 rotates the shaft 20 so that the auxiliary cam is assembled with the shaft 20 (refer to FIG. 5g). Here, when the shaft 20 is rotating relative to the auxiliary cam, the auxiliary cam cannot move relative to the auxiliary cam holder.

[Assembly Process—After the Assembly of the Auxiliary Cam]

After the auxiliary cam has been assembled with the shaft 20, the auxiliary cam holder 710, 720, 730, 740 and 750 that has clamped the auxiliary cam releases the auxiliary cam.

The shaft 20 to which the auxiliary cam has been assembled is moved upward by the drive unit 510, and the rod of the lift unit 520 moves downward so that the shaft 20 and the rod of the lift unit 520 are removed from the auxiliary cam holder (refer to FIG. 5h).

Subsequently, the auxiliary cam holder 710, 720, 730, 740 and 750 moves rearward (refer to FIG. 5i).

[Transfer of the Product]

A robot and an automatic transfer device holds the shaft 20 to which the cams and the auxiliary cam have been assembled.

Thereafter, the member of the drive unit 510 that has clamped the circumferential outer surface of the shaft 20 is operated so that the shaft 20 is removed from the drive unit 510.

The automatic transfer device subsequently transfers the shaft 20 assembled with the cams and the auxiliary cam out of the assembly apparatus

### INDUSTRIAL APPLICABILITY

A camshaft manufactured by the present invention can be used in an engine for vehicles.

1. An apparatus for assembling a cam with a shaft, comprising:
a holder clamping the cam having an opening;
a drive unit clamping the shaft and moving the shaft in a vertical direction so that the shaft is inserted into the opening of the cam, the drive unit rotating the shaft; and
a lift unit provided so as to be movable in the vertical direction so that the lift unit is able to support a lower end of the shaft,
wherein the shaft is inserted into the cam while an upper end of the shaft is clamped by the drive unit and the lower end of the shaft is supported by the lift unit, and
the holder comprises a receiving member receiving a portion of the cam, the receiving member sliding in a front-rear direction, and a support unit supporting a portion of the cam that protrudes out of the receiving member, the support unit sliding in a left-right direction,
wherein while the shaft is moved downwards and inserted into the cam, the support unit does not come into contact with the cam, and while the shaft rotates so that the cam is fastened to the shaft, the support unit comes into contact with the cam.

2. The apparatus according to claim 1, further comprising
an auxiliary cam holder clamping an auxiliary cam having a different shape from a shape of the cam, the auxiliary cam holder being disposed above the holder and provided so as to be slidable relative to the holder.

3. A method of assembling a cam to a shaft, comprising:
providing the cam having a depression therein;
inserting the shaft provided with a protrusion into the cam; and
assembling the cam with the shaft in such a way that the shaft is rotated relative to the cam,
wherein in the inserting, the shaft is inserted into the cam while an upper end of the shaft is fixed and a lower end thereof is supported,
while the shaft is inserted into the cam, the cam can move relative to the shaft, and while the shaft rotates relative to the cam, the cam is fixed.
